(19) United States
(12) Patent Application Publication
(10) Pub. No.: US 2025/0371762 A1
(43) Pub. Date: Dec. 4, 2025

(54) PATTERN DATA GENERATION

(71) Applicant: ADOBE INC., SAN JOSE, CA (US)

(72) Inventors: Abhishek Rai, Noida (IN); Indranil Bit, West Bengal (IN); Arup Dey, Marathahalli (IN); Sai Keerthana Karnam, Kurnool State - Andhra Pradesh (IN); R Tejaswini, Hyderabad (IN); Sumit Dhingra, Delhi (IN); Ankit Phogat, Haryana (IN); Vineet Batra, Delhi (IN); Pranav Vineet Aggarwal, Santa Clara, CA (US); Ajinkya Gorakhnath Kale, San Jose, CA (US)

(21) Appl. No.: 18/678,757

(22) Filed: May 30, 2024

(51) Int. Cl. G06T 11/60; G06T 7/10; G06V 10/764; G06V 20/70

(52) U.S. Cl. CPC G06T 11/60; G06T 7/10; G06V 10/764; G06V 20/70

(57) ABSTRACT

A method, apparatus, non-transitory computer readable medium, apparatus, and system for generating pattern data include obtaining an input image including a pattern element. Then, embodiments generate a pattern image including the pattern element based on the input image. The pattern image includes a plurality of versions of the pattern element. Subsequently, embodiments generate a pattern caption based on the pattern image. Embodiments then utilize the pattern image and the pattern caption for training an image generation model to generate pattern images based on a text prompt.

### BACKGROUND

The following relates generally to image processing, and more specifically to pattern image generation. Image processing is a type of data processing that involves the manipulation of an image to get the desired output, typically utilizing specialized algorithms and techniques. Image processing is used to perform operations on an image to enhance its quality or to extract useful information from it. This process usually comprises a series of steps that includes the importation of the image, its analysis, manipulation to enhance features or remove noise, and the eventual output of the enhanced image or salient information it contains.

Pattern images are images that can be stitched together in a process known as “tiling” to provide backgrounds and design elements. Images that can be stitched together seamlessly are sometimes referred to as “tile-able images.” In some cases, image generation models struggle to generate tile-able images due to a lack in the amount or quality of the training data used to train the image generation models.

### SUMMARY

Systems and methods for generating pattern data are described herein. Embodiments of the present inventive concept include a pattern generation apparatus that is configured to extract elements from non-pattern input images, arrange the elements into one or more geometric layouts, and perform one or more additional transformations to the arranged elements to synthesize a pattern. Embodiments additionally generate captions for the synthesized pattern that describe both the elements in the pattern as well as arrangement and color details about the pattern. In some cases, embodiments further classify the synthesized pattern to determine if it is suitable for inclusion in a training dataset. In this way, embodiments are configured to generate pattern data for direct use or for training an image generation model to generate higher quality patterns.

A method, apparatus, non-transitory computer readable medium, and system for pattern image generation are described. One or more aspects of the method, apparatus, non-transitory computer readable medium, and system include obtaining an input image including a pattern element; generating a pattern image including the pattern element based on the input image, wherein the pattern image includes a plurality of versions of the pattern element; generating a pattern caption based on the pattern image; and utilizing the pattern image and the pattern caption for training an image generation model to generate images based on a text prompt.

A method, apparatus, non-transitory computer readable medium, and system for pattern image generation are described. One or more aspects of the method, apparatus, non-transitory computer readable medium, and system include obtaining an input image including at least one element and an input caption describing the at least one element; generating a pattern image based on the at least one element; generating a pattern caption based on the pattern image and the input caption; performing a quality classification on the pattern image; and adding the pattern image and the pattern caption to a pattern dataset based on the quality classification.

An apparatus, system, and method for pattern image generation are described. One or more aspects of the apparatus, system, and method include at least one processor; at least one memory storing instructions executable by the at least one processor; a pattern synthesizing component configured to generate a pattern image based on an element from an input image; a captioning component configured to generate an input caption based on the input image, and to generate a pattern caption based on the pattern image and the input caption; and a quality classifier configured to perform a quality classification on the pattern image.

### BRIEF DESCRIPTION OF THE DRAWINGS

FIG. 1 shows an example of a pattern generation system according to aspects of the present disclosure.

FIG. 2 shows an example of a pattern data generation apparatus according to aspects of the present disclosure.

FIG. 3 shows an example of an image classification pipeline according to aspects of the present disclosure.

FIG. 4 shows an example of an aesthetic classification pipeline according to aspects of the present disclosure.

FIG. 5 shows an example of a pipeline for generating an input caption according to aspects of the present disclosure.

FIG. 6 shows an example of a pattern synthesis pipeline according to aspects of the present disclosure.

FIG. 7 shows an example of a pipeline for generating a pattern caption according to aspects of the present disclosure.

FIG. 8 shows an example of a method for generating pattern data according to aspects of the present disclosure.

FIG. 9 shows an example of an image generation model according to aspects of the present disclosure.

FIG. 10 shows an example of a method for providing a pattern image to a user according to aspects of the present disclosure.

FIG. 11 shows an example of a pipeline for training an image generation model according to aspects of the present disclosure.

FIG. 12 shows an example of a method for training an image generation model according to aspects of the present disclosure.

FIG. 13 shows an example of a computing device according to aspects of the present disclosure.

### DETAILED DESCRIPTION

Pattern images, also referred to herein as “pattern data,” refers to images that can be tiled together seamlessly. In some cases, the images are vector images. “Vector” refers to the underlying representation of the image, a vector image format. A vector image format refers to a type of digital graphic representation that utilizes mathematical equations to define paths and shapes, rather than mapping individual pixels, facilitating scalable and resolution-independent rendering of the image elements. This format allows for precise manipulation of image attributes such as colors, shapes, and outlines without degradation in quality, making it a preferred format for logos and illustrations.

In some cases, users wish to generate vector pattern data for use in their designs, or as training data for training generative models. However, even the largest available stock image datasets do not have a large amount of pattern data. Furthermore, it can be difficult to yield the patterns from these datasets, as the images may be improperly labeled or of low quality.

In some cases, it is possible to generate pattern-like images by prompting image generation models. However, the current available state-of-the-art generative models are typically trained on realistic images. While the vector style can be achieved in some cases with careful prompting, the synthesized images are usually not tile-able.

It is possible to generate tile-able patterns purely algorithmically, where the algorithms are based in mathematical ideas such as fractal equations. Some of these rule-based patterns include “Truchet tiles” and “Escheresque fractals.” However, these generation algorithms are inherently geometric and represent only a subset of the diverse range of patterns encountered in the real world.

Embodiments of the present inventive concepts are configured to generate pattern data by arranging assets into a pattern. Embodiments include a pattern generation apparatus configured to extract assets from a dataset using a segmentation component, which then classifies the images. The assets are classified as either “isolated” or “composite”, where isolated images include a single foreground element, and composite images include multiple different foreground elements. The elements (sometimes referred to herein as “pattern elements”) are extracted, and an aesthetic classifier assigns each element an aesthetic score, which quantifies how visually pleasing an image is. In some cases, this classification further considers the image's adherence to the vector style. Elements with an aesthetic score over a certain threshold are selected for further processing.

Embodiments further include a captioning component for generating descriptive captions of each image. In some cases, the captioning component includes an image-to-text model, such as BLIP-2 or LLaVA, which can describe the content of each element. The captioning component is additionally configured to augment the captions with additional words describing the generated pattern, such as “pattern”, “[color] background”, “hexagonal arrangement”, and so forth.

Once these assets are classified as isolated or composite, filtered by aesthetic score, and include a starting caption, a pattern synthesizing component arranges the assets into a tile-able pattern. In some embodiments, patterns are created with 1-3 unique elements, and arranged on top of nodes within a grid such as a square grid, a brick grid, or a hexagonal grid. The assets can be further transformed, through recoloring, scaling, or rotating. However, in some cases, the assets that overlap corner and side boundary nodes are not transformed, or transformed in the exact same way as each other, so as to ensure seamless tiling. The pattern synthesizing component then may adjust the color palette of the pattern, generating patterns with differently colored assets and backgrounds. According to some aspects, the captioning component augments the caption of the pattern to include description for the transformations and/or the placement.

Embodiments of the disclosure improve on existing image generation methods by enabling more accurate synthesis of pattern images and pattern image datasets. For example, patterns can be generated based on stock images using automatically generated captions. In some embodiments, assets used in the pattern generation are filtered by aesthetic score and the final synthesized patterns are classified to determine their inclusion in a pattern dataset, thereby ensuring the pattern dataset includes high quality patterns and captions. Accordingly, some embodiments provide automated systems and methods for creating pattern datasets that can be used to train an image generation model to generate high quality patterns.

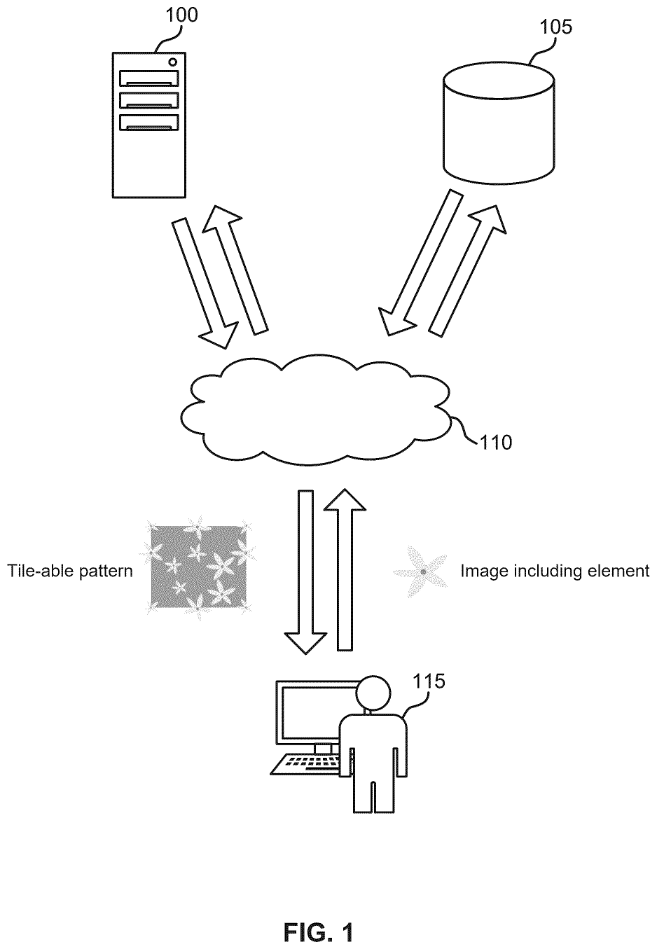

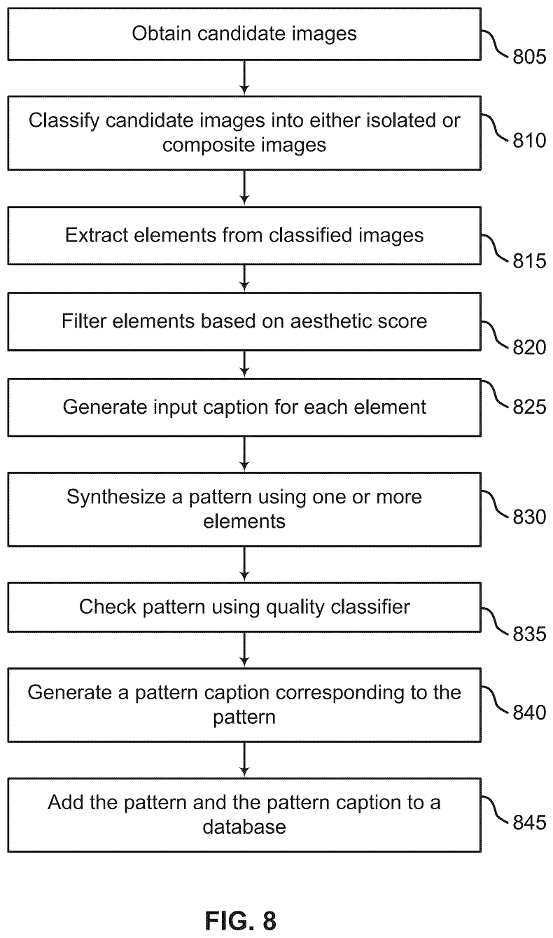

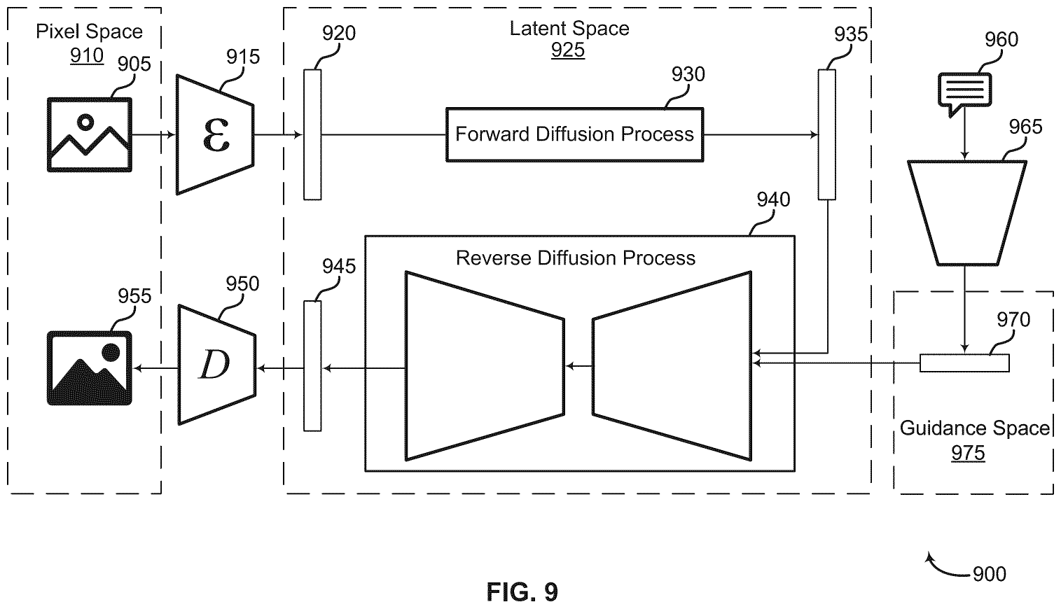

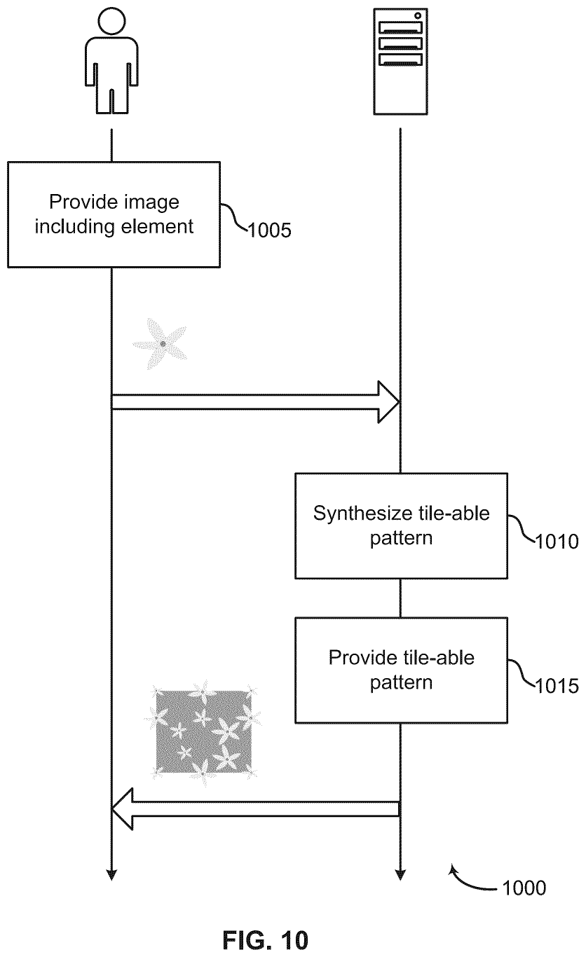

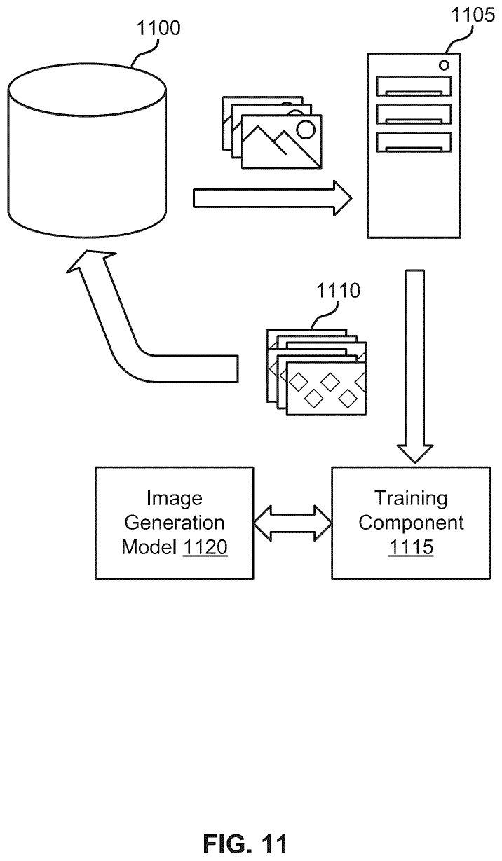

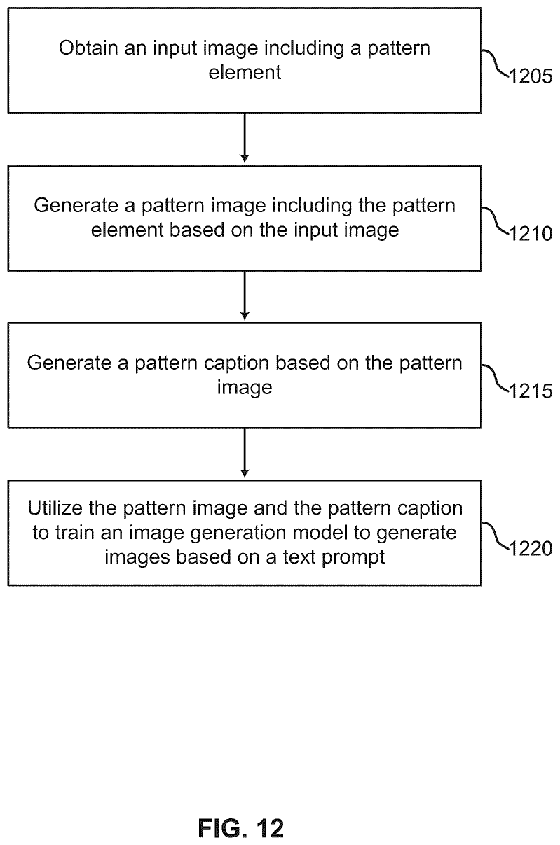

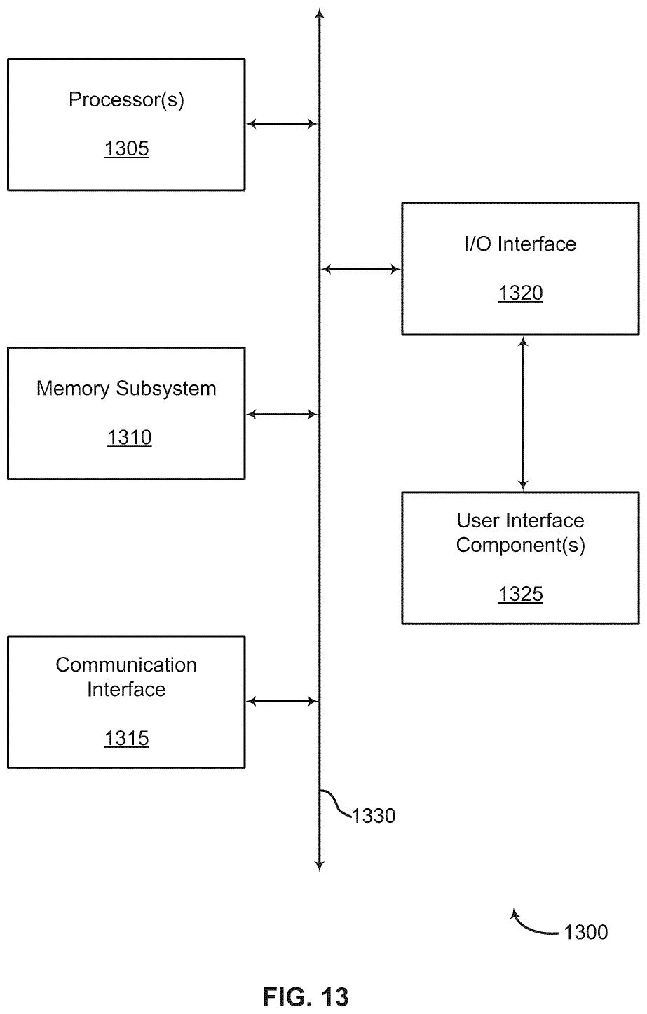

A pattern generation system is described with reference to FIGS. 1-7. Methods for generating pattern data are described with reference to FIGS. 8 and 10. Methods for training an image generation model are described with reference to FIGS. 11-12. An embodiment of the image generation model is described with reference to FIG. 9. A computing device configured to implement a pattern generation apparatus is described with reference to FIG. 13.

### Pattern Generation System

An apparatus for pattern image generation is described. One or more aspects of the apparatus include at least one processor; at least one memory storing instructions executable by the at least one processor; a pattern synthesizing component configured to generate a pattern image based on an element from an input image; a captioning component configured to generate an input caption based on the input image, and to generate a pattern caption based on the pattern image and the input caption; and a quality classifier configured to perform a quality classification on the pattern image.

Some examples of the apparatus, system, and method further include a segmentation component configured to segment the input image to obtain a segmented image of the element from the input image. Some examples further include an aesthetic classifier configured to perform an aesthetic classification on the input image. Some examples further include a database configured to store the generated pattern images.

FIG. 1 shows an example of a pattern generation system according to aspects of the present disclosure. The example shown includes pattern generation apparatus 100, database 105, network 110, and user 115. In an example use case, user 115 uploads an image including an element to the system. For example, the user may upload a photo of a flower, where the flower is the element. Then, pattern generation apparatus 100 extracts the element from the image, and synthesizes a tile-able pattern including the pattern element. In some cases, the pattern generation apparatus 100 provides the synthesized pattern to the user 115, database 105, or both.

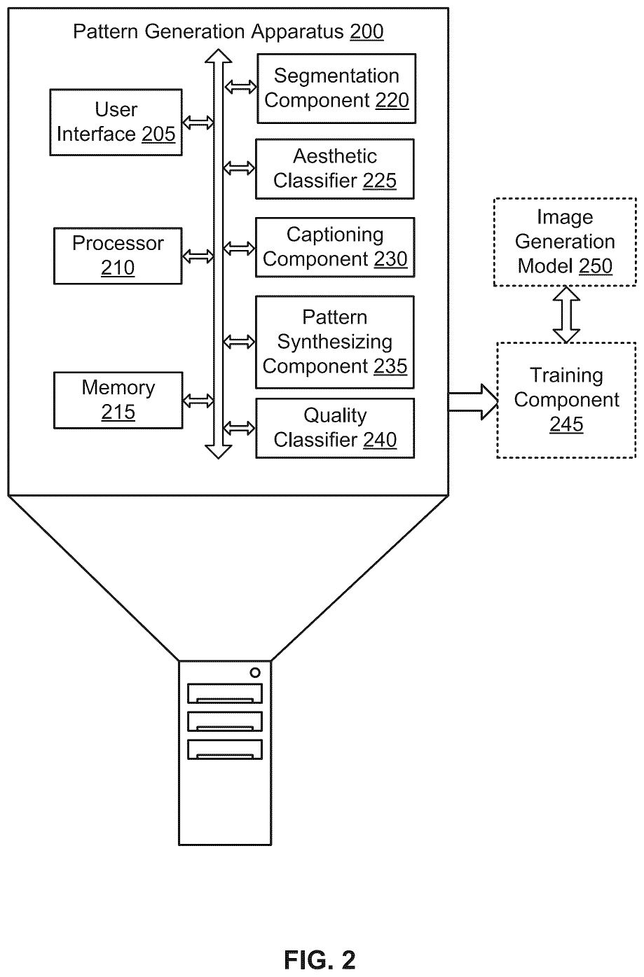

In some embodiments, pattern generation apparatus 100 may be implemented in whole or in part on a server. A server provides one or more functions to users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general purpose computing device, a personal computer, a laptop computer, a mainframe computer, a super computer, or any other suitable processing apparatus. Pattern generation apparatus 100 is an example of, or includes aspects of, the corresponding element described with reference to FIGS. 2 and 11.

Database 105 stores information used by the pattern generation system, such as stock images, synthesized patterns, model parameters, configuration files, instructions executable by the pattern generation apparatus 100, and the like. A database is an organized collection of data. For example, a database stores data in a specified format known as a schema. A database may be structured as a single database, a distributed database, multiple distributed databases, or an emergency backup database. In some cases, a database controller may manage data storage and processing in database 105. In some cases, a user interacts with a database controller. In other cases, the database controller may operate automatically without user interaction. Database 105 is an example of, or includes aspects of, the corresponding element described with reference to FIGS. 8 and 11.

Network 110 is used to facilitate the transfer of information between pattern generation apparatus 100, database 105, and user 115. The network 110 is sometimes referred to as the “cloud.” A cloud is a computer network configured to provide on-demand availability of computer system resources, such as data storage and computing power. In some examples, the cloud provides resources without active management by the user. The term cloud is sometimes used to describe data centers available to many users over the Internet. Some large cloud networks have functions distributed over multiple locations from central servers. A server is designated an edge server if it has a direct or close connection to a user. In some cases, a cloud is limited to a single organization. In other examples, the cloud is available to many organizations. In one example, a cloud includes a multi-layer communications network comprising multiple edge routers and core routers. In another example, a cloud is based on a local collection of switches in a single physical location.

FIG. 2 shows an example of a pattern data generation apparatus according to aspects of the present disclosure. The example shown includes pattern generation apparatus 200, user interface 205, processor 210, memory 215, segmentation component 220, aesthetic classifier 225, captioning component 230, pattern synthesizing component 235, quality classifier 240, training component 245, and image generation model 250.

User interface 205 enables a user to interact with pattern generation apparatus 200. In some embodiments, the user interface 205 includes an audio device, such as an external speaker system, an external display device such as a display screen, or an input device (e.g., remote control device interfaced with the user interface directly or through an IO controller module). In some cases, a user interface 205 includes a graphical user interface (GUI).

Processor 210 is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). In some cases, processor 210 is configured to operate memory 215 array using a memory controller. In other cases, a memory controller is integrated into processor 210. In some cases, processor 210 is configured to execute computer-readable instructions stored in memory 215 to perform various functions. In some embodiments, processor 210 includes special purpose components for modem processing, baseband processing, digital signal processing, or transmission processing.

Memory 215 stores information used by pattern generation apparatus 200 such as model parameters, executable instructions, training data, and images. Examples of a memory 215 device include random access memory (RAM), read-only memory (ROM), or a hard disk. Examples of memory devices include solid state memory and a hard disk drive. In some examples, memory 215 is used to store computer-readable, computer-executable software including instructions that, when executed, cause processor 210 to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within the memory 215 store information in the form of a logical state.

Some components of pattern generation apparatus 200, such as segmentation component 220, aesthetic classifier 225, captioning component 230, quality classifier 240, and image generation model 250 may include an artificial neural network (ANN). An ANN is a hardware or a software component that includes a number of connected nodes (i.e., artificial neurons), which loosely correspond to the neurons in a human brain. Each connection, or edge, transmits a signal from one node to another (like the physical synapses in a brain). When a node receives a signal, it processes the signal and then transmits the processed signal to other connected nodes. In some cases, the signals between nodes comprise real numbers, and the output of each node is computed by a function of the sum of its inputs. In some examples, nodes may determine their output using other mathematical algorithms (e.g., selecting the max from the inputs as the output) or any other suitable algorithm for activating the node. Each node and edge is associated with one or more node weights that determine how the signal is processed and transmitted.

During the training process, these weights are adjusted to improve the accuracy of the result (i.e., by minimizing a loss function which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

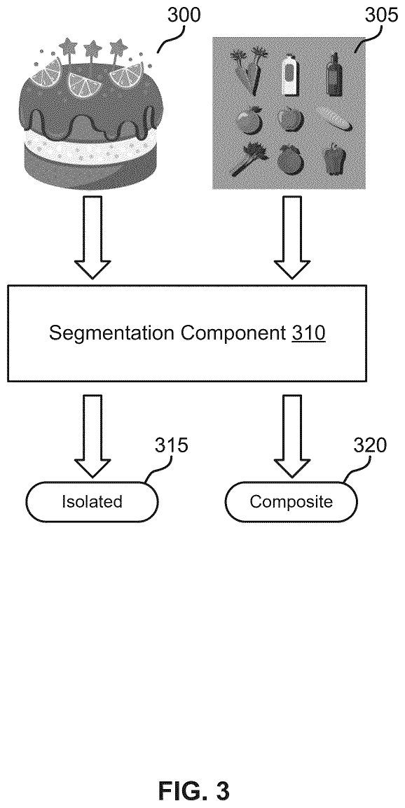

Segmentation component 220 is configured to identify one or more elements from an image. An element may be an object within the image, for example, a food item, a character, an animal, a flower, etc. Segmentation component 220 may perform one or more computer vision techniques such as instance segmentation, semantic segmentation, panoptic segmentation, convolution operations, or a combination thereof to identify element(s) in an image. Embodiments of segmentation component 220 further include a classifier to determine if an image is either “isolated” or “composite.” An image is an “isolated” image if the image contains only one element, otherwise, it is a “composite” image. The classifier may use machine learning (ML) techniques to perform the classification, or may use the result of the segmentation operation to perform the classification (e.g., if the segmentation component determines there is only a single foreground element, then the image is classified as “isolated,” or classified as “composite” otherwise). In some cases, segmentation component 220 extracts the element(s) from the image for use with the other components of pattern generation apparatus 200. The extraction process may involve removing a background from the image, and then identifying bounding boxes or paths corresponding to the regions of the image occupied by the elements. Removing the background may include identifying a shape according to its Z-order in a vector image file format, and/or may include using an ANN to identify and remove the background. Segmentation component 220 is an example of, or includes aspects of, the corresponding element described with reference to FIG. 3.

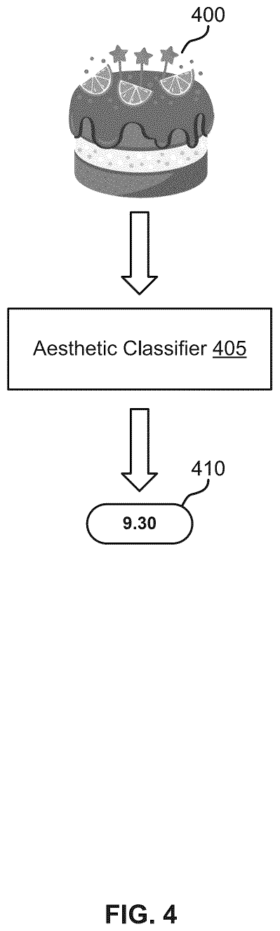

Aesthetic classifier 225 generates an “aesthetic score” for an image that quantifies how visually pleasing the image is. Embodiments of aesthetic classifier 225 include an ML model such as the LAION aesthetic classifier. An image may be classified as “aesthetic” or “not aesthetic” based on whether its aesthetic score exceeds a threshold value. According to some aspects, aesthetic classifier 225 performs an aesthetic classification on the input image, where the pattern image is generated based on the aesthetic classification. For example, aesthetic classifier 225 may remove any elements extracted by segmentation component 220 that are below a threshold value, thereby preventing the elements from being used in pattern synthesis. Aesthetic classifier 225 is an example of, or includes aspects of, the corresponding element described with reference to FIG. 4.

Captioning component 230 is configured to generate a caption that describes an element in an image, and further to augment the generated caption with description about the synthesized pattern containing the element. Embodiments of captioning component 230 include a transformer-based encoder as well as a decoder configured to generate natural language from an output of the encoder. A transformer or transformer network is a type of neural network models used for natural language processing tasks. A transformer network transforms one sequence into another sequence using an encoder and a decoder. Encoder and decoder include modules that can be stacked on top of each other multiple times. The modules comprise multi-head attention and feed forward layers. The inputs and outputs (target sentences) are first embedded into an n-dimensional space. Positional encoding of the different words (i.e., give every word/part in a sequence a relative position since the sequence depends on the order of its elements) are added to the embedded representation (n-dimensional vector) of each word. In some examples, a transformer network includes attention mechanism, where the attention looks at an input sequence and decides at each step which other parts of the sequence are important. The attention mechanism involves query, keys, and values denoted by Q, K, and V, respectively. Q is a matrix that contains the query (vector representation of one word in the sequence), K are all the keys (vector representations of all the words in the sequence) and V are the values, which are again the vector representations of all the words in the sequence. For the encoder and decoder, multi-head attention modules, V consists of the same word sequence than Q. However, for the attention module that is taking into account the encoder and the decoder sequences, V is different from the sequence represented by Q. In some cases, values in V are multiplied and summed with some attention-weights a.

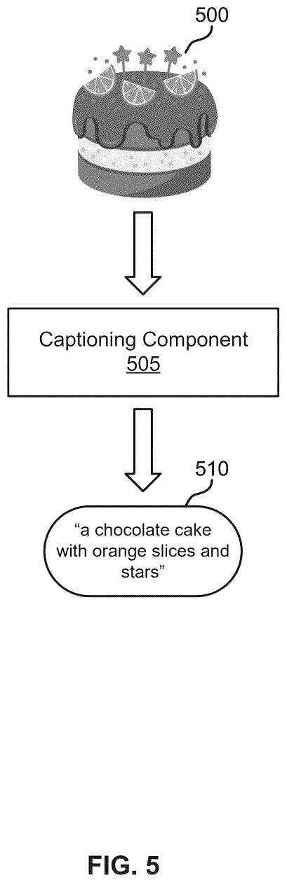

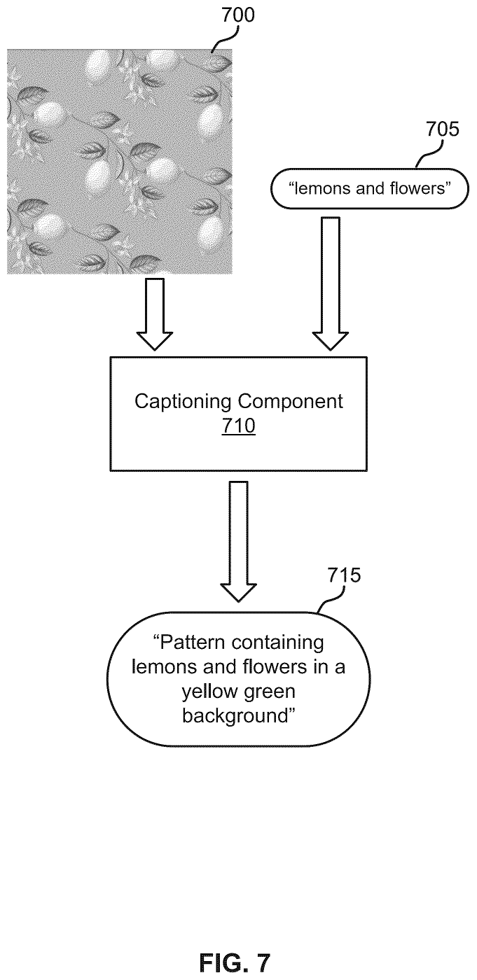

According to some aspects, captioning component 230 is configured to generate an input caption based on the input image, and to generate a pattern caption based on the pattern image and the input caption. The input caption may be a description of an object in the image. The pattern caption may include the input caption, as well as additions. For example, an input caption may be “birthday cake,” and the pattern caption may be: “A pattern of a birthday cake on a blue background.” In some examples, captioning component 230 combines a set of input captions corresponding to a set of elements in the pattern image. Captioning component 230 is an example of, or includes aspects of, the corresponding element described with reference to FIGS. 5 and 7.

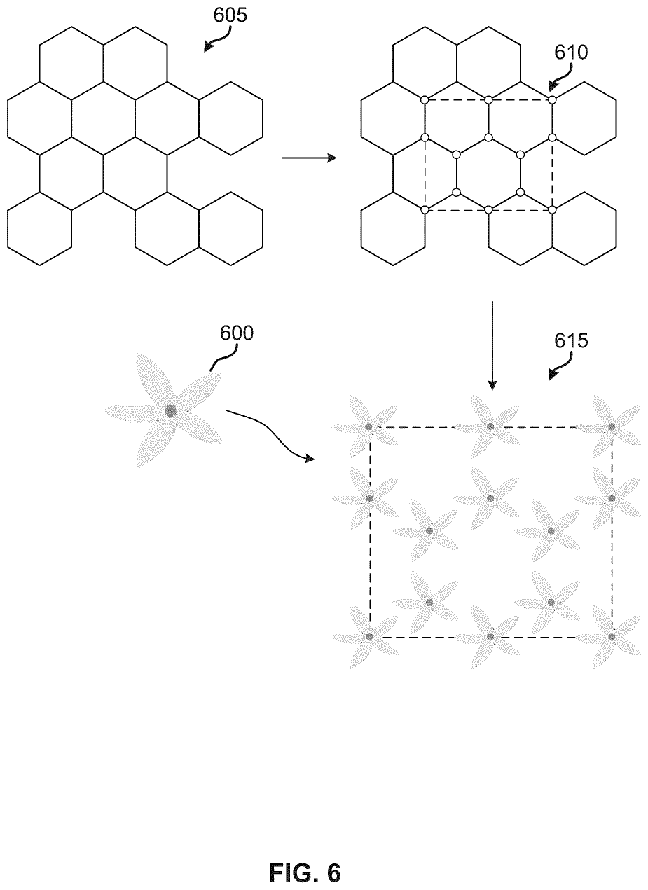

According to some aspects, pattern synthesizing component 235 generates a pattern image including the pattern element based on the image. Embodiments of the pattern synthesizing component 235 arrange elements extracted from segmentation component 235 onto a geometric template including nodes, and may optionally perform additional transformations on the elements such as rotations, scaling, or color adjustments. In some examples, pattern synthesizing component 235 repeatedly positions the element in the pattern image based on the geometric template. In some examples, pattern synthesizing component 235 positions a plurality of pattern elements onto the geometric template, wherein elements within the plurality of pattern elements are different from each other. This process is described in detail with reference to FIG. 6.

Quality classifier 240 classifies a synthesized pattern image as either suitable or not suitable for addition to a pattern dataset. Embodiments of quality classifier include an aesthetic classifier that is the same as or similar to aesthetic classifier 225, as well as an encoder for generating features, such as a feature vector, from an input pattern image. The encoder may be based on the CLIP encoder. In some cases, the aesthetic classifier 225 uses the generated features to determine if the synthesized pattern image is similar to other pattern images in the pattern data set. For example, if a synthesized pattern image is above a similarity threshold with respect to one or more existing pattern images in the pattern dataset, it may classify the pattern image as unsuitable. Some embodiments of the quality classifier 240 include a binary classifier that is trained on positive data and negative data. For example, the training component 245 may create positive data by filtering a stock image dataset for “patterns,” and then employing the aesthetic classifier 225 to further filter the results. The training component 245 may create negative data by extracting non-patterns from the stock image dataset, including icons, logos, illustrations, and other images that do not tile together. Then, the training component 245 may update parameters of aesthetic classifier 225 in a training phase based on the positive training data and the negative training data. In this way, quality classifier 240 ensures the aesthetic quality and uniqueness of the patterns produced by pattern generation apparatus 200.

Training component 245 is configured to prepare training data for and to update parameters of pattern generation apparatus 200. According to some aspects, training component 245 trains, using the pattern image created by the pattern synthesizing component 235 and the pattern caption generated by the captioning component 230, an image generation model 250 to generate pattern images based on a text prompt. In some examples, training component 245 creates a training set for the image generation model 250 by generating a set of pattern images based on a set of input images and generating a set of pattern captions corresponding to the set of pattern images, respectively. In some examples, training component 245 computes a diffusion loss based on the pattern image. In some examples, training component 245 updates parameters of the image generation model 250 based on the diffusion loss. Training component 245 is an example of, or includes aspects of, the corresponding element described with reference to FIG. 11.

Image generation model 250 is configured to generate images from an input prompt, such as a text description of the image to be generated. In contrast to the rule-based executable code included in pattern synthesizing component 235, image generation model 250 includes an ANN generator. Embodiments of image generation model 250 are based on a diffusion model, which will be described in reference to FIG. 9. According to some aspects, image generation model 250 may be finetuned using the pattern data generated by pattern generation apparatus 200 to reliably produce pattern images from prompts, such as from prompts including the word “pattern.”

FIG. 3 shows an example of an image classification pipeline according to aspects of the present disclosure. The example shown includes first image 300, second image 305, segmentation component 310, first classification 315, and second classification 320. Segmentation component 310 is an example of, or includes aspects of, the corresponding element described with reference to FIG. 2.

In this example, both first image 300 and second image 305 are input to segmentation component 310. Segmentation component 310 performs a segmentation operation, such as panoptic segmentation, on the images. Then, based on the results of the segmentation operation, segmentation component 310 classifies first image 300 as first classification 315 and second image 305 as second classification 320. For example, segmentation component 310 may remove background content from the images, and then segment first image 300 to identify the birthday cake portion of the image. Since only one element, the birthday cake, is identified from first image 300, the first image 300 may be classified as “isolated.” In contrast, the segmentation component 310 may identify multiple elements from second image 305, such as the pair of carrots, the milk carton, the drink bottle, and the fruits. Since there are a plurality of element instances, the second image 305 may be classified as “composite.” In some cases, the segmentation component 310 extracts all element instances for further processing, e.g., aesthetic classification and pattern synthesis.

FIG. 4 shows an example of an aesthetic classification pipeline according to aspects of the present disclosure. The example shown includes input image 400, aesthetic classifier 405, and aesthetic score 410. Aesthetic classifier 405 is an example of, or includes aspects of, the corresponding element described with reference to FIG. 2.

In this example, aesthetic classifier 405 receives input image 400. Input image may be a “whole” image, including both background and foreground elements, or may be an element extracted from the segmentation component described with reference to FIG. 3. Then, aesthetic classifier 405 processes input image 400 to generate aesthetic score 410, which is a measure of the aesthetic quality of the image. Embodiments of aesthetic classifier 405 include an ANN, such as the LAION-Aesthetics_Predictor, though embodiments are not limited thereto and other models configured to generate a classification based on image data may be used.

FIG. 5 shows an example of a pipeline for generating an input caption 510 according to aspects of the present disclosure. The example shown includes input image 500, captioning component 505, and input caption 510. Captioning component 505 is an example of, or includes aspects of, the corresponding element described with reference to FIGS. 2 and 7.

Captioning component 505 may be used to both generate an initial caption (referred to herein as an “input caption) that describes the element of an image, and then to augment that initial caption to form a pattern caption that describes the pattern including the pattern element (referred to herein as a “pattern caption”). In this example, captioning component 505 receives input image 500. Input image may be a “whole” image, including both background and foreground elements, or may be an element extracted from the segmentation component described with reference to FIG. 3. Captioning component 505 then generates input caption 510 from input image 500. Embodiments of captioning component 505 include a captioning model such as BLIP-2 or LLaVA.

FIG. 6 shows an example of a pattern synthesis pipeline according to aspects of the present disclosure. The example shown includes element 600, geometric node arrangement 605, selected nodes for arranging elements 610, and elements arranged on nodes 615. The pipeline that may be performed by a pattern synthesis component as described with reference to FIG. 2. The element 600 may be extracted by a segmentation component as described with reference to FIG. 2.

In some cases, geometric node arrangement 605 includes a 2-dimensional geometric template including grid of nodes that are spaced at regular intervals. In some examples, the geometric template are spaced evenly, such as in a square matrix. In some examples, alternating rows of the square matrix are shifted to the left or right to form a “brick” arrangement. According to some aspects, the nodes are placed at the intersections of the lines that form the shapes within the geometric template. In some embodiments, the nodes are not spaced evenly, e.g., forming rectangular or quadrilateral or triangular shapes.

In the example illustrated in FIG. 6, the geometric node arrangement 605 includes a hexagonal geometric template. The placement of the nodes may be described by Equation 1 as follows:

$$\begin{matrix}x = 1. 5 * a * i \\ y = \sqrt{3} * a * ( j + \frac{i \%2}{2} )\end{matrix} \qquad ( 1 )$$

where ‘a’ is the length of one side of the hexagon in some unit (such as a pixel), and ‘i’ and ‘j’ are integers representing the row and column indices, respectively, and ‘x’ and ‘y’ represent the positions of the node on a plane. The pattern generation system then selects a set of nodes from the geometric template that correspond to a repeatable tile. In this example, these nodes are the selected nodes for arranging elements 610. The nodes are highlighted in FIG. 6 as circle shapes.

Then, the pattern generation system repeatedly places the element 600 on the selected nodes for arranging elements 610 to produce elements arranged on nodes 615. The pipeline may stop here; elements arranged on nodes 615 is indeed a repeatable pattern. That is, repeating the image formed by elements arranged on nodes 615 to fill an area will result in a seamless pattern. In some cases, embodiments further apply transformations to the placed elements such as rotations, scaling, or color adjustments. In some cases, repeating the pattern results in the nodes on the upper edge for one tile becoming the nodes on the lower edge for the tile above it, and similarly so for the nodes on the right edges and left edges. Accordingly, either no transformations or the same transformation(s) may be applied to all of the elements on the edge nodes. Embodiments may further add a background color or gradient to fill in the space between the elements.

FIG. 7 shows an example of a pipeline for generating a pattern caption 715 according to aspects of the present disclosure. The example shown includes pattern image 700, input caption 705, captioning component 710, and pattern caption 715. Input caption 705 is an example of, or includes aspects of, the corresponding element described with reference to FIG. 5. Captioning component 710 is an example of, or includes aspects of, the corresponding element described with reference to FIGS. 2 and 5.

In this example, the captioning component 710 augments the input caption 705 based on the pattern image 700 to form pattern caption 715. According to some aspects, the captioning component 710 performs prompt engineering to augment the caption. For example, the captioning component 710 may augment the caption using the following schema: “” A pattern of”+caption[0]+“and”+ . . . +caption[n]+“on a”+color+“background,” where caption[0] . . . caption[n] are input captions describing the elements in the pattern. According to some aspects, the pattern image 700 and the pattern caption 715 are added to a pattern dataset after being classified as suitable by a quality classifier as described with reference to FIG. 2.

### Pattern Data Generation

A method for pattern image generation is described. One or more aspects of the method include obtaining an input image including at least one element and an input caption describing the at least one element; generating a pattern image based on the at least one element; generating a pattern caption based on the pattern image and the input caption; performing a quality classification on the pattern image; and adding the pattern image and the pattern caption to a pattern dataset based on the quality classification.

Some examples of the method, apparatus, non-transitory computer readable medium, and system further include training, using the pattern dataset, an image generation model to generate pattern images based on a text prompt. Some examples further include segmenting the input image to obtain a segmented image of the element, wherein the pattern image is generated based on the segmented image.

In some aspects, the pattern image includes a plurality of pattern elements from the input image. In some aspects, the pattern image includes an additional element from an additional image. Some examples of the method, apparatus, non-transitory computer readable medium, and system further include performing an aesthetic classification on the input image, wherein the pattern image is generated based on the aesthetic classification.

FIG. 8 shows an example of a method 800 for generating pattern data according to aspects of the present disclosure. In some cases, there is an insufficient amount of pattern data available to train an image generation model to generate pattern images. The method 800 describes a process for generating additional pattern data from a sparse initial dataset. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 805, the system obtains candidate images. The candidate images may be from a stock image dataset. In some embodiments, the candidate images include images in the vector format, or images that are tagged as “vector” images which includes vector-styled images. At operation 810, the system classifies candidate images into either isolated or composite images. At operation 815, the system extracts elements from classified images. Operations of steps 810 and 815 may be performed by a segmentation component as described with reference to FIGS. 2 and 3.

At operation 820, the system filters elements based on aesthetic score. The operations of this step may be performed by an aesthetic classifier as described with reference to FIGS. 2 and 4. In some embodiments, the aesthetic classifier generates aesthetic scores for each element extracted in step 815. The elements with aesthetic scores below a threshold value may be removed from consideration before proceeding to step 825. At operation 825, the system generates input caption for each element. Operations of this step may be performed by a captioning component in a process that is described with reference to FIGS. 2 and 5. The input caption is a description of the content of the element.

At operation 830, the system synthesizes a pattern using one or more elements. The operations of this step may be performed by a pattern synthesizing component as described with reference to FIGS. 2 and 6. The system may synthesize the pattern by placing the one or more elements on a geometric template as described with reference to FIG. 6. In some embodiments, the system additionally applies one or more transformations to the elements arranged in the geometric template, and may add a background. At operation 835, the system checks pattern using quality classifier. The quality classifier and its functionality is described with reference to FIG. 2.

At operation 840, the system generates a pattern caption corresponding to the pattern. Operations of this step may be performed by a captioning component in a process that is described with reference to FIGS. 2 and 7. The pattern caption may be based on the input caption generated in step 825. At operation 845, the system adds the pattern and the pattern caption to a database. For example, the system may add the pattern and its corresponding pattern caption to a pattern dataset stored on a database as described with reference to FIG. 1. The patterns and the pattern captions may be used directly, or may be used as a training dataset to finetune an image generation model to generate high quality pattern images.

FIG. 9 shows an example of an image generation model according to aspects of the present disclosure. The example shown includes guided latent diffusion model 900, original image 905, pixel space 910, image encoder 915, original image features 920, latent space 925, forward diffusion process 930, noisy features 935, reverse diffusion process 940, denoised image features 945, image decoder 950, output image 955, text prompt 960, text encoder 965, guidance features 970, and guidance space 975.

In some examples, diffusion models are based on a neural network architecture known as a U-Net. The U-Net takes input features having an initial resolution and an initial number of channels, and processes the input features using an initial neural network layer (e.g., a convolutional network layer) to produce intermediate features. The intermediate features are then down-sampled using a down-sampling layer such that down-sampled features have a resolution less than the initial resolution and a number of channels greater than the initial number of channels.

This process is repeated multiple times, and then the process is reversed. That is, the down-sampled features are up-sampled using up-sampling process to obtain up-sampled features. The up-sampled features can be combined with intermediate features having a same resolution and number of channels via a skip connection. These inputs are processed using a final neural network layer to produce output features. In some cases, the output features have the same resolution as the initial resolution and the same number of channels as the initial number of channels.

In some cases, a U-Net takes additional input features to produce conditionally generated output. For example, the additional input features could include a vector representation of an input prompt. The additional input features can be combined with the intermediate features within the neural network at one or more layers. For example, a cross-attention module can be used to combine the additional input features and the intermediate features.

A diffusion process may also be modified based on conditional guidance. In some cases, a user provides a text prompt describing content to be included in a generated image. For example, a user may provide the prompt “a pattern containing lemons and flowers in a yellow green background.” In some examples, guidance can be provided in a form other than text, such as via an image, a sketch, or a layout. The system converts the text prompt (or other guidance) into a conditional guidance vector or other multi-dimensional representation. For example, text may be converted into a vector or a series of vectors using a transformer model, or a multi-modal encoder. In some cases, the encoder for the conditional guidance is trained independently of the diffusion model.

A noise map is initialized that includes random noise. The noise map may be in a pixel space or a latent space. By initializing an image with random noise, different variations of an image including the content described by the conditional guidance can be generated. Then, the system generates an image based on the noise map and the conditional guidance vector.

A diffusion process can include both a forward diffusion process for adding noise to an image (or features in a latent space) and a reverse diffusion process for denoising the images (or features) to obtain a denoised image. The forward diffusion process can be represented as q(xₜ|xₜ₋₁), and the reverse diffusion process can be represented as p(xₜ₋₁|xₜ). In some cases, the forward diffusion process is used during training to generate images with successively greater noise, and a neural network is trained to perform the reverse diffusion process (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse process. During the reverse diffusion process, the model begins with noisy data x_{T}, such as a noisy image and denoises the data to obtain the p(xₜ₋₁|xₜ). At each step t-1, the reverse diffusion process takes xₜ, such as first intermediate image, and t as input. Here, t represents a step in the sequence of transitions associated with different noise levels, The reverse diffusion process outputs xₜ₋₁, such as second intermediate image iteratively until x_{T} is reverted back to x₀, the original image. The reverse process can be represented as:

$${p}_{θ} ( {x}_{t - 1} \vert {x}_{t} ) := N ( {x}_{t - 1} ; {μ}_{θ} ( {x}_{t} , t ) , {Σ}_{θ} ( {x}_{t} , t ) ) . \qquad ( 2 )$$

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) , \qquad ( 3 )$$

where p(x_{T})=N(x_{T}; 0, I) is the pure noise distribution as the reverse process takes the outcome of the forward process, a sample of pure noise, as input and Πₜ₌₁^{T}p_{θ}(xₜ₋₁|xₜ) represents a sequence of Gaussian transitions corresponding to a sequence of addition of Gaussian noise to the sample.

At interference time, observed data x₀ in a pixel space can be mapped into a latent space as input and a generated data \tilde{x} is mapped back into the pixel space from the latent space as output. In some examples, x₀ represents an original input image with low image quality, latent variables x₁, . . . , x_{T} represent noisy images, and \tilde{x} represents the generated image with high image quality.

A diffusion model may be trained using both a forward and a reverse diffusion process. In one example, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

The system then adds noise to a training image using a forward diffusion process in N stages. In some cases, the forward diffusion process is a fixed process where Gaussian noise is successively added to an image. In latent diffusion models, the Gaussian noise may be successively added to features in a latent space.

At each stage n, starting with stage N, a reverse diffusion process is used to predict the image or image features at stage n-1. For example, the reverse diffusion process can predict the noise that was added by the forward diffusion process, and the predicted noise can be removed from the image to obtain the predicted image. In some cases, an original image is predicted at each stage of the training process.

The training system compares predicted image (or image features) at stage n-1 to an actual image (or image features), such as the image at stage n-1 or the original input image. For example, given observed data x, the diffusion model may be trained to minimize the variational upper bound of the negative log-likelihood −log p_{θ}(x) of the training data. The training system then updates parameters of the model based on the comparison. For example, parameters of a U-Net may be updated using gradient descent. Time-dependent parameters of the Gaussian transitions can also be learned.

FIG. 10 shows an example of a method 1000 for providing a pattern image to a user according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1005, a user provides an image including an element. An element may be a foreground object in the image, such as a food item, a plant or an animal, a character, or the like. The user may do so via a user interface as described with reference to FIG. 2. For example, the user may upload their own image, or select an image from a database by operating a GUI.

At operation 1010, the system synthesizes a tile-able pattern. Operations of this step may be performed by a pattern generation apparatus as described with reference to FIG. 2. A tile-able pattern is an image that can be repeated over an area seamlessly to form a background. The synthesizing process is described in detail with reference to FIG. 8. At operation 1015, the system provides the tile-able pattern back to the user. In some embodiments, the system further stores the tile-able pattern in a pattern dataset for later use.

### Training

A method for pattern image generation is described. One or more aspects of the method include obtaining an input image and an input caption describing an element of the image; generating a pattern image including the pattern element based on the image; generating a pattern caption based on the input caption; and training, using the pattern image and the pattern caption, an image generation model to generate pattern images based on a text prompt. Some examples of the method, apparatus, non-transitory computer readable medium, and system further include creating a training set for the image generation model by generating a plurality of pattern images based on a plurality of input images and generating a plurality of pattern captions corresponding to the plurality of pattern images, respectively.

Some examples of the method, apparatus, non-transitory computer readable medium, and system further include segmenting the input image to obtain a segmented image of the element, wherein the pattern image is generated based on the segmented image. In some aspects, the pattern image includes a plurality of pattern elements from the input image. Some examples of the method, apparatus, non-transitory computer readable medium, and system further include performing an aesthetic classification on the input image, wherein the pattern image is generated based on the aesthetic classification. Some examples further include generating the input caption based on the input image.

Some examples of the method, apparatus, non-transitory computer readable medium, and system further include combining a plurality of input captions corresponding to a plurality of pattern elements in the pattern image. Some examples of the method, apparatus, non-transitory computer readable medium, and system further include selecting a geometric template based on the element of the input image. Some examples further include repeatedly positioning the element in the pattern image based on the geometric template.

Some examples of the method, apparatus, non-transitory computer readable medium, and system further include performing a quality classification on the pattern image, wherein the image generation model is trained using the pattern image based on the quality classification. Some examples of the method, apparatus, non-transitory computer readable medium, and system further include computing a diffusion loss based on the pattern image. Some examples further include updating parameters of the image generation model based on the diffusion loss.

FIG. 11 shows an example of a pipeline for training an image generation model 1120 according to aspects of the present disclosure. The example shown includes database 1100, pattern generation apparatus 1105, synthesized patterns and captions 1110, training component 1115, and image generation model 1120. Database 1100 is an example of, or includes aspects of, the corresponding element described with reference to FIGS. 1 and 8. Pattern generation apparatus 1105 is an example of, or includes aspects of, the corresponding element described with reference to FIGS. 1 and 2. Training component 1115 is an example of, or includes aspects of, the corresponding element described with reference to FIG. 2. Image generation model 1120 is an example of, or includes aspects of, the corresponding element described with reference to FIG. 2.

In this example, a pattern generation apparatus 1105 obtains stock images from database 1100. The pattern generation apparatus 1105 then segments the images to remove their backgrounds and extract one or more elements from each image. The elements are filtered by an aesthetic classifier, captioned, and arranged onto a geometric template to form pattern data. Additional detail regarding forming the pattern data is described with reference to FIG. 8. The pattern data includes synthesized patterns and captions 1110. The synthesized patterns and captions 1110 can then be stored in the database 1100 or passed to a training component 1115 which uses trains image generation model 1120 to generate patterns based on a text caption. According to some aspects, the training process entails performing a forward diffusion process on the synthesized pattern to add noise and generate intermediate noisy images as denoising targets. An embedding of the corresponding caption may be incorporated in the forward diffusion process so that the image generation model learns to associate visual features from the synthesized pattern with the caption. Then, the training proceeds as described with reference to FIG. 9. That is, the model learns to denoise images in a reverse diffusion process such that the denoising operation matches the intermediate noisy images, while simultaneously associating the denoising trajectory with language features from the embedding of the caption.

FIG. 12 shows an example of a method 1200 for training an image generation model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1205, the system obtains an input image including a pattern element. In some cases, the operations of this step refer to, or may be performed by, a pattern generation apparatus as described with reference to FIGS. 1, 2, and 11. For example, the pattern generation apparatus may obtain the input image from a database of stock images. In some embodiments, the pattern generation apparatus obtains the input image, and then generates an input caption based on the pattern element as described with reference to FIG. 5.

At operation 1210, the system generates a pattern image including the pattern element based on the input image. In some cases, the operations of this step refer to, or may be performed by, a pattern synthesizing component as described with reference to FIG. 2. Generating the pattern image may include placing the element repeatedly onto nodes in a geometric template. In some cases, the generation includes performing transformations on the placed elements, and adding a background. Additional detail regarding the pattern image generation process is described with reference to FIG. 6.

At operation 1215, the system generates a pattern caption based on the pattern image. In some cases, the operations of this step refer to, or may be performed by, a captioning component as described with reference to FIGS. 2, 5, and 7. The pattern caption includes additional detail about the pattern. For example, the captioning component may augment the input caption, if an input caption was generated based on the pattern element. For example, if the input caption is “a birthday cake,” the pattern caption may be “a pattern of a birthday cake on a blue background.”

At operation 1220, the system utilizes the pattern image and the pattern caption to train an image generation model to generate pattern images based on a text prompt. In some cases, the operations of this step refer to, or may be performed by, a training component as described with reference to FIGS. 2 and 11. According to some aspects, the training process entails prompting the image generation model to perform a generative reverse diffusion process using an embedding of the pattern caption as conditioning. Then, the training component computes a diffusion loss based on differences from the generation process and a target denoised image. The training component then updates parameters of the image generation model based on the diffusion loss. Additional details regarding the training of diffusion-based image generation models is provided with reference to FIG. 9.

FIG. 13 shows an example of a computing device 1300 according to aspects of the present disclosure. The example shown includes computing device 1300, processor(s), memory subsystem 1310, communication interface 1315, I/O interface 1320, user interface component(s), and channel 1330.

In some embodiments, computing device 1300 is an example of, or includes aspects of, pattern generation apparatus 100 of FIG. 1. In some embodiments, computing device 1300 includes one or more processors 1305 that can execute instructions stored in memory subsystem 1310 to obtain an input image and an input caption describing an element of the image; generate a pattern image including the pattern element based on the image; generate a pattern caption based on the input caption; and train, using the pattern image and the pattern caption, an image generation model to generate pattern images based on a text prompt.

According to some aspects, computing device 1300 includes one or more processors 1305. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1310 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1315 operates at a boundary between communicating entities (such as computing device 1300, one or more user devices, a cloud, and one or more databases) and channel 1330 and can record and process communications. In some cases, communication interface 1315 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1320 is controlled by an I/O controller to manage input and output signals for computing device 1300. In some cases, I/O interface 1320 manages peripherals not integrated into computing device 1300. In some cases, I/O interface 1320 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1320 or via hardware components controlled by the I/O controller.

According to some aspects, user interface component(s) 1325 enable a user to interact with computing device 1300. In some cases, user interface component(s) 1325 include an audio device, such as an external speaker system, an external display device such as a display screen, an input device (e.g., a remote control device interfaced with a user interface directly or through the I/O controller), or a combination thereof. In some cases, user interface component(s) 1325 include a GUI.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining an input image including a pattern element;
generating a pattern image including the pattern element based on the input image, wherein the pattern image includes a plurality of versions of the pattern element;
generating a pattern caption based on the pattern image; and
utilizing the pattern image and the pattern caption for training an image generation model to generate images based on a text prompt.

2. The method of claim 1, wherein training the image generation model comprises:
creating a training set for the image generation model by generating a plurality of pattern images based on a plurality of input images and generating a plurality of pattern captions corresponding to the plurality of pattern images, respectively.

3. The method of claim 1, further comprising:
segmenting the input image to obtain a segmented image of the pattern element, wherein the pattern image is generated based on the segmented image.

4. The method of claim 1, wherein:
the pattern image includes a plurality of pattern elements from the input image.

5. The method of claim 1, further comprising:
performing an aesthetic classification on the input image, wherein the pattern image is generated based on the aesthetic classification.

6. The method of claim 1, wherein generating the pattern caption comprises:
generating an input caption based on the input image; and
augmenting the input caption to generate the pattern caption.

7. The method of claim 1, further comprising:
combining a plurality of input captions corresponding to a plurality of pattern elements in the pattern image.

8. The method of claim 1, further comprising:
selecting a geometric template based on the element of the input image; and
repeatedly positioning the element in the pattern image based on the geometric template.

9. The method of claim 1, further comprising:
performing a quality classification on the pattern image, wherein the image generation model is trained using the pattern image based on the quality classification.

10. The method of claim 1, wherein training the image generation model comprises:
computing a diffusion loss based on the pattern image; and
updating parameters of the image generation model based on the diffusion loss.

11. A method comprising:
obtaining an input image including at least one element and an input caption describing the at least one element;
generating a pattern image based on the at least one element;
generating a pattern caption based on the pattern image and the input caption;
performing a quality classification on the pattern image; and
adding the pattern image and the pattern caption to a pattern dataset based on the quality classification.

12. The method of claim 11, further comprising:
training, using the pattern dataset, an image generation model to generate pattern images based on a text prompt.

13. The method of claim 11, further comprising:
segmenting the input image to obtain a segmented image of the element, wherein the pattern image is generated based on the segmented image.

14. The method of claim 11, wherein:
the pattern image includes a plurality of elements from the input image.

15. The method of claim 11, wherein:
the pattern image includes an additional element from an additional image.

16. The method of claim 11, further comprising:
performing an aesthetic classification on the input image, wherein the pattern image is generated based on the aesthetic classification.

17. An apparatus comprising:
at least one processor;
at least one memory storing instructions executable by the at least one processor;
the apparatus further comprising a pattern synthesizing component configured to generate a pattern image based on an element from an input image;
a captioning component configured to generate an input caption based on the input image, and to generate a pattern caption based on the pattern image and the input caption; and
a quality classifier configured to perform a quality classification on the pattern image.

18. The apparatus of claim 17, further comprising:
a segmentation component configured to segment the input image to obtain a segmented image of the element from the input image.

19. The apparatus of claim 17, further comprising:
an aesthetic classifier configured to perform an aesthetic classification on the input image.

20. The apparatus of claim 17, further comprising:
a database configured to store the generated pattern images.
